(19) United States
(12) Patent Application Publication
(10) Pub. No.: US 2004/0221461 A1
(43) Pub. Date: Nov. 11, 2004

(54) Saw blade for reciprocating saws

(76) Inventors: Keith L. Knisley, Hot Springs, AR (US); Scott Ridgeway, Hot Springs, AR (US)

Correspondence Address: Richard C. Litman, LITMAN LAW OFFICES, LTD., P.O. Box 15035, Arlington, VA, 22215, US

(21) Appl. No.: 10/814,156

(22) Filed: Apr. 1, 2004

Related U.S. Application Data
(60) Provisional application No. 60/468,736, filed on May 8, 2003.

(51) Int. Cl. B27B 19/00; B27B 13/02

(52) U.S. Cl. 30/392; 83/835

(57) ABSTRACT

The saw blade for reciprocating saws is an offset saw blade for attaching to a reciprocating saw for making flush cuts around a ninety degree surface. The saw blade includes a mounting arm and an offset blade portion. The blade portion is attached to the mounting arm by a connector arm. The blade portion includes a row of saw teeth on at least one edge of the blade portion. The saw blade also includes at least one stabilizer, such as a gusset plate, disposed along the connector arm for increasing the rigidity of the saw blade.

### CROSS-REFERENCE TO RELATED APPLICATION

This application claims the benefit of U.S. Provisional Patent Application Serial No. 60/468,736, filed May 8, 2003.

### BACKGROUND OF THE INVENTION

1. Field of the Invention

The present invention relates to a saw blade for a reciprocating saw, and more particularly to an offset saw blade for a reciprocating saw that enables making a flush cut around a ninety degree surface.

2. Description of Related Art

The conventional reciprocating power saw is one of the most common and versatile power tools. The reciprocating power saw is very common because it is portable and may easily be used for many different operations. It is often difficult, however, to make flush cuts along floors and walls with conventional reciprocating saws. The saw blade and the reciprocating mechanism are commonly stored in a housing, which makes it difficult to position the saw blade against a flat surface, such as a wall or a floor. It is also not possible to make flush cuts around ninety degree angle surfaces with the conventional reciprocating saw for the same reason. The following patent documents disclose inventions that have attempted to improve the flush-cut ability of the conventional reciprocating saw.

Japanese Patent No. 2001-158,002 discloses a replaceable, reciprocating saw blade. The drawings show a blade having the shape of a section of a circle, with a flat blade back and a row of saw teeth on the opposite, arcuate, lower side.

European Patent Application No. 882,537 and U.S. Pat. No. 6,233,833, issued to Grant et al., disclose a reciprocating saw with a clamp for receiving a blade in different orientations. A blade may be oriented in the saw clamp in four ninety degree offset orientations with the blade teeth facing in the same directions as the top, bottom, left and right side of the saw. The blade is received and held in place by a clamp. A retainer is located in the clamp and is movable from an open to a closed position to allow the blade to be inserted and removed from the saw.

U.S. Pat. No. 5,940,977, issued to Moores, Jr. et al., discloses a reciprocating saw with an angular blade drive and a rotatable blade holder. The rotatable blade holder receives a saw blade and holds it into position on the saw. The rotatable blade holder allows the blade to be rotated to different cutting angles along an axis that is perpendicular to the saw.

U.S. Pat. No. 4,985,031, issued to Buss et al., discloses a left and right inferior border osteotomy blade saw. The blade saw has first and second straight arm portions forming an obtuse angle between them. The end of the second arm terminates in an end portion on which a cutting blade is mounted. Supplying reciprocating linear motion to the first arm allows the saw to be used to cut bone. The blade saw is used to cut the borders of the mandible through hard to reach incisions in the mouth.

U.S. Pat. No. 4,630,368, issued to Izzi, Sr., discloses flush cut handsaws. The handsaws have a generally planar handle oriented in a plane perpendicular to, and parallel to, the saw blade axis. Saw teeth are located on one side of the saw blade. The saw blade is positioned in this manner so that it may lay flat on a horizontal surface, such as a floor, while it is making a cut. The saw is particularly useful for cutting off plastic plumbing pipes flush with the floor surface that they are protruding from.

U.S. Pat. No. 4,553,306, issued to Mineck, discloses a reciprocating saw offset blade holder. The holder is a modification for a sabre saw that supports the saw blade on the top of an adapter for making flush cuts along the intersection between floors and walls. The Mineck invention is an improvement on an existing reciprocating saw adapter. Grooves and tapped holes are provided in the existing adapter so that the existing saw blade securing clip can be used to clamp a saw blade to the adapter with the plane of the blade vertical and the teeth of the blade extending upwardly beyond the level of the top of the housing for making flush-to cuts. The improved adapter may be used for making flush-to cuts and flush-with cuts.

None of the above inventions provide a reciprocating saw blade for making flush cuts in areas where there is an angled structure.

The above inventions all provide straight reciprocating saw blades. A straight reciprocating saw blade does not permit making a flush cut around a ninety degree surface. Therefore, there is a need for an improved reciprocating saw blade that provides the ability to make flush cuts around ninety degree surfaces. It would further be beneficial to provide a ninety degree flush-cut saw blade that may be easily mounted to any conventional reciprocating saw. Finally, a ninety degree flush-cut saw blade that minimizes damage and repair work to the surface being cut is desirable.

None of the above inventions and patents, taken either singly or in combination, is seen to describe the instant invention as claimed.

### SUMMARY OF THE INVENTION

The present invention is a saw blade for a reciprocating saw that allows the saw to make flush cuts around ninety degree angle surfaces. The saw blade has a mounting arm, a connector arm and a blade portion. The mounting arm is adapted to attach to any conventional reciprocating saw. A first end of the mounting arm is releasably secured to the reciprocating saw and a second end of the mounting arm is attached to the connector arm. The first end of the mounting arm preferably has a through-hole that will receive a blade mounting projection on any conventional reciprocating power saw.

The blade portion is attached to the mounting arm in an offset configuration. The blade portion is attached to the mounting arm by the connector arm. The mounting arm and the blade portion are disposed in offset parallel planes with the connector positioned perpendicular to them both. From a side view the saw blade appears to be formed as a step with the blade portion positioned below the mounting arm a distance equal to the length of the connector arm.

The saw blade also includes at least one stabilizer for increasing the rigidity of the saw blade. Because the blade portion is offset from the mounting arm, it does not have much support from the reciprocating saw housing. The stabilizer(s) provides additional support to the blade portion for improved cutting strength. The stabilizers are positioned on the connector arm between the mounting arm and the blade portion. An additional stabilizer may be positioned on the top surface of the mounting arm.

Accordingly, it is a principal object of the invention to provide a reciprocating saw blade that provides the ability to make flush cuts around ninety degree surfaces.

It is another object of the invention to provide a ninety degree flush-cut saw blade that may be easily mounted to any conventional reciprocating saw.

It is a further object of the invention to provide a ninety degree flush-cut saw blade that minimizes damage and repair work to the surface being cut.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a saw blade for a reciprocating saw according to the present invention.

FIG. 2 is a perspective view of a saw blade for a reciprocating saw according to the present invention.

FIG. 3 is a side view of the saw blade according to the present invention.

Similar reference characters denote corresponding features consistently throughout the attached drawings.

### DETAILED DESCRIPTION OF THE PREFERRED EMBODIMENTS

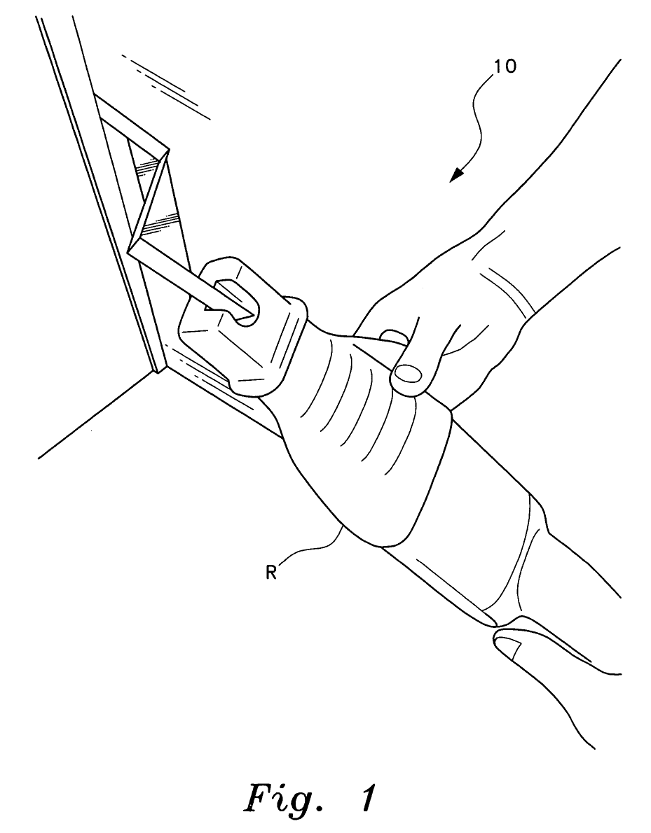

The present invention is a saw blade for a reciprocating saw that provides an offset blade for making flush cuts around ninety degree surfaces with a conventional reciprocating saw. The offset saw blade is easily attached to any conventional reciprocating saw. FIG. 1 is an environmental, perspective view of the saw blade 10 attached to a conventional reciprocating saw R. The saw blade 10 is depicted cutting around a ninety degree surface.

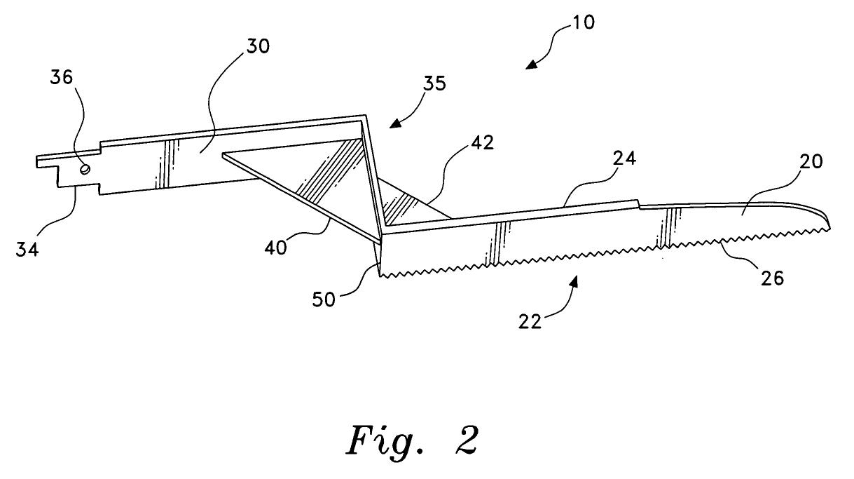

FIG. 2 depicts a perspective view of the saw blade 10 detached from the reciprocating saw R. The saw blade 10 comprises a mounting arm 30, a connector arm 50 and a blade portion 20. The mounting arm 30 has an attachment end 34 and a distal second end 35. The attachment end 34 preferably has a through-hole 36 defined therein for receiving a screw or mounting pin that retains the blade 10 in the chuck of the reciprocating saw R.

The second end 35 of the mounting arm 30 is attached to the connector arm 50. The connector arm 50 is disposed perpendicular to the mounting arm 30 and the blade portion 20. The blade portion 20 is attached to the opposite end of the connector arm 50. The connector arm 50 offsets the blade portion 20 from the mounting arm 30 so that the mounting arm 30 and the blade 20 are disposed in parallel planes. The blade portion 20 is separated from the mounting arm 30 a distance equal to the length of the connector arm 50.

The blade portion 20 has a first end connected to the connector arm 50 and a second end that is free to engage the cutting surface. The blade portion 20 has at least one cutting edge 22. The cutting edge 22 comprises a row of saw teeth 26 disposed along the entire length of the cutting edge 22. The blade portion 20 may optionally comprise an additional cutting edge on the opposite edge of the of the blade portion 20. Depending on the type of application the reciprocating saw R is used for, it is often beneficial to have saw teeth 26 on more than one edge of the blade portion 20.

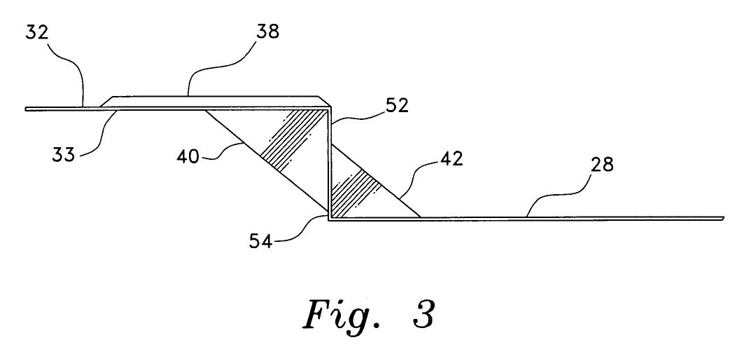

The saw blade 10 further comprises at least one stabilizer. Because the blade portion 20 is offset from the mounting arm 30 it does not have much support from the housing of the reciprocating saw R. The stabilizer provides additional support to the blade portion 20 for improved cutting strength. The stabilizers are shown in FIG. 3. The preferred embodiment of the present invention comprises two main stabilizers 40, 42, which consist of gusset plates. The first stabilizer 40 is preferably a gusset plate positioned between the mounting arm 30 and the connector arm 50. The first stabilizer 40 is disposed along the bottom surface 33 of the mounting arm 30 and the back surface 54 of the connector arm 50 (the terms “bottom surface 33” and “back surface 54” have reference to the orientation shown in FIG. 3, the mounting arm 30 being flat and having a top surface 32, a bottom surface 33, and opposing side edges extending into and out of the page; similarly the connector arm 50 is flat, having a front surface 52, back surface 54, and opposing edges extending into and out of the drawing page). The second stabilizer 42 is preferably a second gusset plate positioned between the blade portion 20 and the connector arm 50. The second stabilizer 42 is disposed along the top surface 28 of the blade portion 20 and the front surface 52 of the connector arm 50 (the term “top surface 28” refers to the orientation of the blade portion 20 as seen in FIG. 3, the cutting edge 22 extending into the drawing sheet). An additional stabilizing rib 38 is optionally disposed along the top surface 32 of the mounting arm 30. As shown in FIG. 1, both the first stabilizer 40 and the second stabilizer 42 should preferably be located in a transversely centrally aligned position with respect to the connector arm 50.

The present saw blade 10 allows for flush cutting around ninety degree angles that is not possible with straight saw blades. The saw blade 10 minimizes the amount of repair work that needs to be done because there is no damage caused by faulty cuts, since the saw blade 10 allows the reciprocating saw R to easily fit into smaller places to make accurate cuts. In particular, the blade portion 20 may be placed flush against a wall, floor, or other surface to cut flush into or around a 90° corner, since the longitudinal axis of the body of the saw R is offset from the longitudinal axis of the blade portion 20 by the length of the connector arm 50. The saw blade 10 may be designed to cut metal, wood, tile and any other material.

It is to be understood that the present invention is not limited to the sole embodiments described above, but encompasses any and all embodiments within the scope of the following claims.

We claim:

1. A saw blade for a reciprocating power saw, comprising:
a flat, elongated mounting arm having a saw mounting end adapted for attachment to the reciprocating saw and having a second end;
a flat, elongated connector arm having a first end attached to the second end of the mounting arm, the connector arm and the mounting arm forming a dihedral angle of about 90°; and
a flat, elongated cutting blade having a first end connected to the second end of the connector arm and having a second end, the cutting blade having a first cutting edge defined by a plurality of teeth, the cutting blade and the connector arm forming a dihedral angle of about 90°, the cutting blade and the mounting arm being parallel to each other and extending in opposite directions from the connector arm;
whereby the cutting blade is capable of being placed flush against one surface of a 900 corner in order to cut around the corner, the cutting blade being offset from the mounting arm by a distance substantially equal to the length of the connector arm.

2. The saw blade according to claim 1, wherein said cutting blade includes a second a cutting edge defined by a plurality of teeth, said second cutting edge being located on the edge opposite the first cutting edge.

3. The saw blade according to claim 1, further comprising a first stabilizer attached to said mounting arm and said connector arm.

3. The saw blade according to claim 2, wherein said first stabilizer is a gusset plate.

4. The saw blade according to claim 1, further comprising a second stabilizer attached to said connector arm and cutting plate.

5. The saw blade according to claim 4, further comprising a reinforcing rib attached to a side of said cutting blade opposite to said gusset plate.

6. The saw blade according to claim 4, wherein said second stabilizer is a gusset plate.

7. The saw blade according to claim 4, further comprising a first stabilizer attached to said mounting arm and said connector arm.

8. The saw blade according to claim 7, wherein said first stabilizer is a gusset plate.

9. The saw blade according to claim 8, wherein said gusset plates are located in a transversely centrally aligned position within said connector plate.

10. In combination, a saw blade and a reciprocating power saw, comprising:
a flat, elongated mounting arm having a saw mounting end adapted for attachment to said reciprocating saw and having a second end;
a flat, elongated connector arm having a first end attached to the second end of the mounting arm, the connector arm and the mounting arm forming a dihedral angle of about 90°; and
a flat, elongated cutting blade having a first end connected to the second end of the connector arm and having a second end, the cutting blade having a cutting edge defined by a plurality of teeth, the cutting blade and the connector arm forming a dihedral angle of about 90°, the cutting blade and the mounting arm being parallel to each other and extending in opposite directions from the connector arm;
whereby the cutting blade is capable of being placed flush against one surface of a 90° corner in order to cut around the corner, the cutting blade being offset from the mounting arm by a distance substantially equal to the length of the connector arm.

11. The combination according to claim 10, wherein said cutting blade includes a second a cutting edge defined by a plurality of teeth, said second cutting edge being located on the edge opposite the first cutting edge.

12. The combination according to claim 10, further comprising a first stabilizer attached to said mounting arm and said connector arm.

13. The combination according to claim 12, wherein said first stabilizer is a gusset plate.

14. The combination according to claim 10, further comprising a second stabilizer attached to said connector arm and cutting plate.

15. The combination according to claim 14, further comprising a reinforcing rib attached to a side of said cutting blade opposite to said gusset plate.

16. The combination according to claim 14, wherein said second stabilizer is a gusset plate.

17. The combination according to claim 14, further comprising a first stabilizer attached to said mounting arm and said connector arm.

18. The combination according to claim 17, wherein said first stabilizer is a gusset plate.

19. The combination according to claim 18, wherein said gusset plates are located in a transversely centrally aligned position within said connector plate.
